(19) United States
(12) Patent Application Publication
(10) Pub. No.: US 2026/0366511 A1
(43) Pub. Date: Nov. 19, 2026

(54) METHOD FOR MANUFACTURING COMPRESSOR, AND METHOD FOR PREDICTING LIFETIME OF COMPRESSOR

(71) Applicant: MITSUBISHI ELECTRIC CORPORATION, Tokyo (JP)

(72) Inventors: Kenji KOJIMA, Chiyoda-ku, Tokyo (JP); Satoru TOYAMA, Chiyoda-ku, Tokyo (JP); Kengo HIRATSUKA, Chiyoda-ku, Tokyo (JP)

(73) Assignee: MITSUBISHI ELECTRIC CORPORATION, Tokyo (JP)

(21) Appl. No.: 19/477,553

(22) PCT Filed: Apr. 28, 2023
(86) PCT No.: PCT/JP2023/016925

§ 371 Date: Oct. 22, 2025

(51) Int. Cl. F04C 28/28; G05B 23/02

(52) U.S. Cl. CPC F04C 28/28; G05B 23/0283; F04C 2230/85; F04C 2270/80

(57) ABSTRACT

A method for manufacturing a compressor includes preparing a used compressor. The method for manufacturing a compressor also includes estimating a degradation state of a sliding portion of the used compressor. The method for manufacturing a compressor further includes manufacturing a new compressor by replacing a first refrigerator oil contained in the used compressor with a new second refrigerator oil, the degradation state in the used compressor satisfying a prescribed criterion.

### TECHNICAL FIELD

The present disclosure relates to a method for manufacturing a compressor, and a method for predicting a lifetime of a compressor.

### BACKGROUND ART

For example, Japanese Patent Laying-Open No. 2009-156504 (PTL 1) discloses a refrigeration cycle apparatus using refrigerant. This refrigeration cycle apparatus includes an indoor unit, an outdoor unit, and a refrigerant pipe connecting the indoor unit and the outdoor unit. Japanese Patent Laying-Open No. 2009-156504 discloses a method for reusing an existing refrigerant pipe when changing a conventional refrigerant to a different refrigerant in the refrigeration cycle apparatus.

### CITATION LIST

### Patent Literature

PTL 1: Japanese Patent Laying-Open No. 2009-156504

### SUMMARY OF INVENTION

### Technical Problem

In general, although a compressor is degraded as a refrigeration cycle apparatus is used, it is preferable to reuse the degraded compressor from the perspective of environmental protection and the like.

The present disclosure has been made to solve the above-described problem, and an object of the present disclosure is to manufacture a new compressor by reusing a used compressor, and to predict a lifetime of the new manufactured compressor.

### Solution to Problem

A method for manufacturing a compressor of the present disclosure includes preparing a used compressor. This manufacturing method also includes estimating a degradation state of a sliding portion of the used compressor. This manufacturing method further includes manufacturing a new compressor by replacing a first refrigerator oil contained in the used compressor with a new second refrigerator oil, the degradation state in the used compressor satisfying a prescribed criterion.

### Advantageous Effects of Invention

According to the present disclosure, it is possible to manufacture a new compressor by reusing a used compressor, and to predict a lifetime of the new manufactured compressor.

### BRIEF DESCRIPTION OF DRAWINGS

FIG. 1 is a diagram showing an exemplary configuration of a refrigeration cycle apparatus.

FIG. 2 is a diagram showing an exemplary configuration of a compressor.

FIG. 3 is an exemplary flowchart of a manufacturing method.

FIG. 4 is a flowchart illustrating a process of step S4 in FIG. 3.

FIG. 5 is a diagram for illustrating usage data.

FIG. 6 is a diagram showing an exemplary relationship between a good parameter and an additive material.

FIG. 7 is a diagram showing an exemplary relationship between the good parameter and the additive material.

FIG. 8 is a flowchart illustrating a method for predicting a lifetime of a new compressor.

FIG. 9 is a diagram showing exemplary correlation information.

FIG. 10 is a diagram showing an exemplary relationship between a good parameter and an additive material in another embodiment.

FIG. 11 is a diagram showing an exemplary relationship between a good parameter and an additive material in another embodiment.

FIG. 12 is a flowchart of a lifetime prediction method.

### DESCRIPTION OF EMBODIMENTS

Embodiments of the present disclosure will be hereinafter described in detail with reference to the drawings. In the drawings, the same or corresponding parts are denoted by the same reference characters, and description thereof will not be repeated. It is also originally intended to use at least some of features described in the embodiments in any appropriate combination.

### First Embodiment

### Exemplary Configuration of Refrigeration Cycle Apparatus

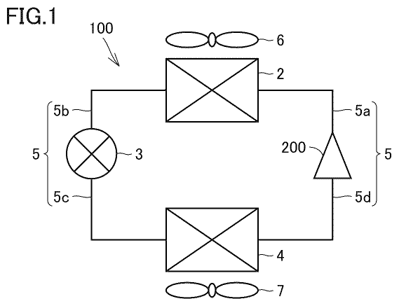

A method for manufacturing a compressor is disclosed in the present disclosure. This compressor is used, by way of example, in a refrigeration cycle apparatus. FIG. 1 is a diagram showing an exemplary configuration of a refrigeration cycle apparatus 100 of the present embodiment. Refrigeration cycle apparatus 100 includes a compressor 200, a condenser 2, an expansion valve 3, and an evaporator 4. Compressor 200 is typically a hermetic refrigerant compressor.

Compressor 200 and condenser 2 are connected to each other by a pipe 5a. Condenser 2 and expansion valve 3 are connected to each other by a pipe 5b. Expansion valve 3 and evaporator 4 are connected to each other by a pipe 5c. Evaporator 4 and compressor 200 are connected to each other by a pipe 5d. Pipe 5a, pipe 5b, pipe 5c, and pipe 5d form a refrigerant circuit 5. Refrigerant is enclosed so as to circulate in refrigeration cycle apparatus 100 (refrigerant circuit 5).

When refrigerant is sucked into compressor 200, compressor 200 compresses this refrigerant. Condenser 2 cools the gaseous refrigerant, which has been compressed by compressor 200, into high-pressure liquid refrigerant or gas-liquid two-phase refrigerant. Expansion valve 3 decompresses the high-pressure liquid refrigerant or gas-liquid two-phase refrigerant. Evaporator 4 heats the decompressed refrigerant into low-pressure gaseous refrigerant. Compressor 200 sucks and re-compresses the refrigerant which has been converted into the low-pressure gaseous refrigerant. In this manner, refrigerant circulates in refrigeration cycle apparatus 100.

A blower 6 blows air to condenser 2. The air blowing of blower 6 promotes refrigerant flowing in condenser 2 to exchange heat with air and thereby absorb or release heat. A blower 7 blows air to evaporator 4. The air blowing of blower 7 promotes refrigerant flowing in evaporator 4 to exchange heat with air and thereby absorb or release heat.

Refrigeration cycle apparatus 100 may be any of an apparatus capable of both cooling and heating, an apparatus capable of cooling only, and an apparatus capable of heating only, for example.

### Exemplary Configuration of Compressor

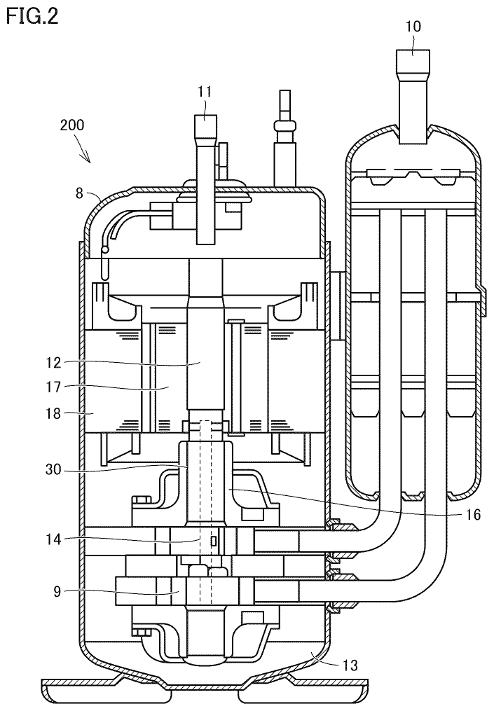

FIG. 2 is a diagram showing an exemplary configuration of compressor 200. FIG. 2 shows an exemplary rotary compressor. As shown in FIG. 2, compressor 200 includes a shell 8, a compression mechanism 9, a suction pipe 10, a discharge pipe 11, a shaft 12, an oil receptacle 13, an oil supply hole 14, a bearing 16, a rotor 17, and a stator 18.

Compression mechanism 9 is disposed within shell 8. Suction pipe 10 and discharge pipe 11 are connected to compression mechanism 9. Suction pipe 10 is a pipe for allowing refrigerant into compressor 200. Discharge pipe 11 is a pipe for discharging refrigerant out of compressor 200. Compression mechanism 9 compresses refrigerant flowing from suction pipe 10 into shell 8, and discharges the refrigerant from discharge pipe 11.

Compressor 200 includes a motor portion. The motor portion includes shaft 12, rotor 17 and stator 18. Compressor 200 is driven by this motor portion.

Compressor 200 includes at least one sliding portion. The sliding portion is where one portion and another portion of compressor 200 contact each other. Typically, one portion is a metal and another portion is a metal or an organic material. The sliding portion is, for example, a contact portion between a shaft and a bearing (a contact portion between shaft 12 and bearing 16), a contact portion between a vane and a piston, or a tooth tip portion of an orbiting scroll. Compressor 200 may include multiple sliding portions. FIG. 2 shows the contact portion between shaft 12 and bearing 16 as an example of a sliding portion 30.

Oil receptacle 13 stores refrigerator oil. The refrigerator oil is supplied to the sliding portion within compression mechanism 9 through oil supply hole 14 by the action of a pump (not shown). Since the refrigerator oil comes into contact with refrigerant in compressor 200, the refrigerant partially dissolves in the refrigerator oil. The refrigerator oil is, for example, polyvinyl ether-based refrigerator oil.

### Reuse of Compressor

In general, because of improved reliability of refrigeration cycle apparatus 100 (e.g., an air conditioner), compressor 200 is often reusable even after the end of useful life (e.g., legal useful life) of this compressor 200. It is also rare for sludge to form even after the end of useful life of refrigeration cycle apparatus 100. On the other hand, the compressor may have failed or may be about to fail due to significant wear of the sliding portion and the like, which results from the state of use of refrigeration cycle apparatus 100 by a user and the like.

Even when compressor 200 is normally operating at the time of collection of such refrigeration cycle apparatus 100, compressor 200 may fail before reaching the end of legal lifetime by being further used. Such a compressor that fails before reaching the end of legal lifetime is also referred to as a “defective compressor.” Metal parts and the like of such a defective compressor may be removed and reused from the perspective of environmental protection and the like.

On the other hand, there are compressors that can be used to reach the end of legal lifetimes by being reused. Conventionally, metal parts and the like of such a compressor have been removed and reused in the same manner as the defective compressor. It is preferable, however, for such a compressor to be made reusable again as new a compressor so that it can be reused.

The inventors found that it is preferable to determine the state of a sliding portion when determining whether or not a compressor can be reused. Further, the inventors disassembled compressors and the like collected from the market and observed their sliding portions. Through these observations, the inventors found that the compressors include various sliding portions such as an intact sliding portion and a sliding portion just prior to the occurrence of seizure.

By disassembling a compressor and visually checking the state of a sliding portion in this manner, for example, an operator can determine whether or not the compressor can be reused. However, disassembling a compressor in order to determine whether or not the compressor can be reused involves an increased number of steps such as the disassembly and the inspection of the compressor. Accordingly, disassembling a compressor and manufacturing a new compressor may lead to a higher cost than manufacturing a compressor from new components. Therefore, it is preferable to be able to clearly evaluate the state of a sliding portion without disassembling a compressor, in order to determine whether or not the compressor can be reused. The method for manufacturing a compressor of the present embodiment is a method that enables manufacture of a new compressor by reusing a used compressor without disassembling the used compressor.

### Method for Manufacturing Compressor

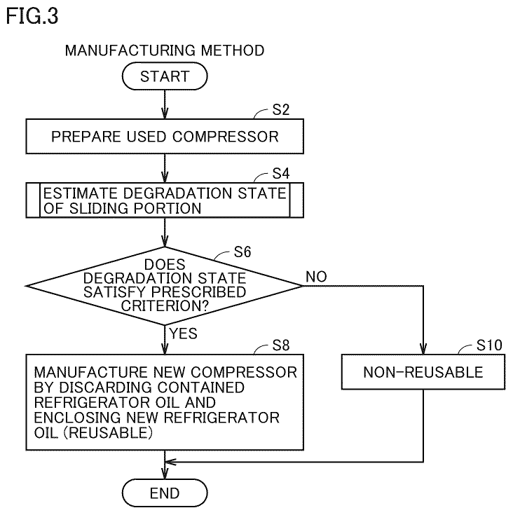

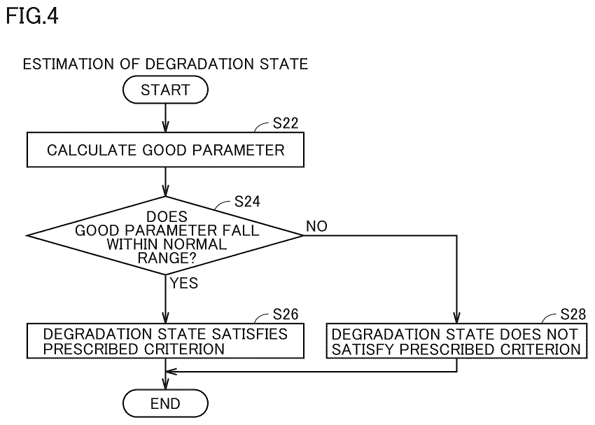

FIG. 3 is an exemplary flowchart of a method for manufacturing a new compressor of the present embodiment. At least some of steps in the flowcharts of FIG. 3, and of FIGS. 4, 8 and 12 described later, may be executed by an operator. In other words, all of the steps in these flowcharts may be executed by the operator. Some of the steps in these flowcharts may be executed by the operator and the remaining steps may be executed by a manufacturing apparatus (such as a robot). All of the steps in these flowcharts may be executed by the manufacturing apparatus. The following describes an example in which all of the steps are executed mainly by the operator.

First, in step S2, a used compressor 200 is prepared. Next, in step S4, a degradation state of a sliding portion of this compressor 200 is estimated. The degradation state of the sliding portion is typically a “wear state” of the sliding portion.

Next, in step S6, it is determined whether or not the estimated degradation state satisfies a prescribed criterion. When it is determined that the degradation state satisfies the prescribed criterion in step S6 (YES in step S6), it is determined that used compressor 200 is reusable in step S8.

A refrigerator oil contained in used compressor 200 is hereinafter also referred to as a “first refrigerator oil.” In step S8, the first refrigerator oil contained in used compressor 200 is discarded. After the first refrigerator oil in used compressor 200 is discarded, a new refrigerator oil is contained in oil receptacle 13 (see FIG. 2). A new compressor 200 is thus manufactured. The new refrigerator oil is also referred to as a “second refrigerator oil.” The second refrigerator oil is mixed with a prescribed additive (such as an antioxidant) in advance.

On the other hand, when it is determined that the degradation state does not satisfy the prescribed criterion in step S6 (NO in step S6), it is determined that used compressor 200 is non-reusable. Metal parts of used compressor 200 determined to be non-reusable may be reused.

FIG. 4 is a flowchart illustrating details of the process of step S4 (estimation of the degradation state) in FIG. 3. In step S22, a good parameter is calculated. The good parameter is a parameter indicating goodness of the sliding portion of compressor 200. According to the present embodiment, as the good parameter is larger, the sliding portion of compressor 200 is better. A method for calculating the good parameter will be described later.

Next, in step S24, it is determined whether or not the calculated good parameter falls within a normal range (a prescribed range). The normal range is a predetermined range, and a method for determining the normal range will be described later. When the good parameter falls within the normal range (YES in step S24), it is determined that the degradation state of the sliding portion satisfies the prescribed criterion in step S26. Then, a return is made to the flowchart of FIG. 3, and it is determined as YES in step S6 of FIG. 3. When the good parameter does not fall within the normal range (NO in step S24), it is determined that the degradation state of the sliding portion does not satisfy the prescribed criterion in step S26. Then, a return is made to the flowchart of FIG. 3, and it is determined as NO in step S6 of FIG. 3.

### Good Parameter

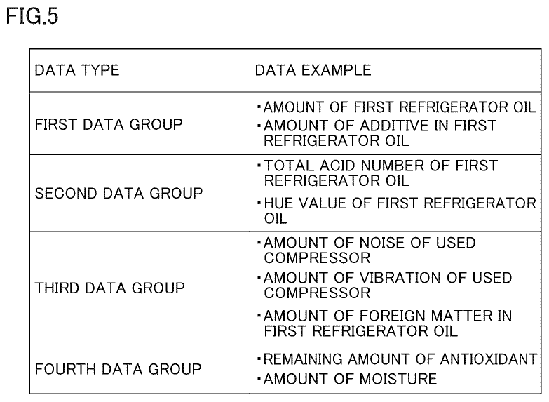

Next, usage data for use in calculation of the good parameter described later is described. FIG. 5 is a diagram for illustrating the usage data. As shown in the example of FIG. 5, the usage data may include a first data group, a second data group, a third data group, and a fourth data group. The first data group and the second data group together correspond to “refrigerator oil data” of the present disclosure. The “refrigerator oil data” is data related to the first refrigerator oil. The first data group corresponds to “first data” of the present disclosure. The second data group corresponds to “second data” of the present disclosure. The third data group corresponds to “compressor data” of the present disclosure.

The first data group is data related to goodness of the sliding portion. Stated another way, the first data group is data indicating goodness of the sliding portion. As shown in FIG. 5, the first data group includes at least one of an amount of the first refrigerator oil and an amount of an additive in the first refrigerator oil. The additive is a substance added to the first refrigerator oil. The additive is, for example, an antiwear agent. The antiwear agent is, for example, tricresyl phosphate. As the first refrigerator oil, polyvinyl ether-based refrigerator oil to which tricresyl phosphate is added as the antiwear agent is used.

The inventors found that as the amount of the first refrigerator oil and the amount of the additive are larger, the sliding portion tends to be better. Therefore, the amount of the first refrigerator oil and the amount of the additive in the first refrigerator oil were adopted as the first data group.

As a method for obtaining the amount of the first refrigerator oil, for example, an operator cuts a pipe (such as suction pipe 10 and discharge pipe 11 in FIG. 2) and collects the first refrigerator oil from the cut portion. Then, the operator measures an amount of the collected first refrigerator oil.

As a method for obtaining the amount of the first refrigerator oil, a sensor may be used. An ultrasonic sensor is used, for example, as the sensor. As a first method using an ultrasonic sensor, the ultrasonic sensor emits ultrasonic waves into a bottom surface of used compressor 200, and measures a length of time for the ultrasonic waves to be reflected at a liquid surface and received by the ultrasonic sensor. The ultrasonic sensor then calculates a distance based on the length of time. This distance is a value corresponding to a liquid level of the contained first refrigerator oil. The amount of the first refrigerator oil is obtained based on this distance, The first method is disclosed in Japanese Patent No. 4123764.

As a second method using an ultrasonic sensor, the ultrasonic sensor palpates a side surface of the compressor, to obtain a level of the first refrigerator oil based on a signal shape. Specifically, in the second method, the ultrasonic sensor emits ultrasonic waves horizontally into the side surface of used compressor 200. Then, a liquid level of the first refrigerator oil is obtained based on, for example, the difference in propagation characteristics between gas refrigerant and liquid refrigerant in which the first refrigerator oil is dissolved. The second method is disclosed, for example, in Japanese Patent No. 6808039.

As a method using a capacitance sensor, the capacitance sensor is installed on the side surface of used compressor 200. In general, a dielectric constant of gas refrigerant is different from a dielectric constant of refrigerator oil (including refrigerator oil with refrigerant dissolved therein). A liquid level of the first refrigerator oil is obtained based on this difference in dielectric constant. The method using a capacitance sensor is disclosed, for example, in Japanese Patent Laying-Open No. 2021-56134.

As a method using a spectrometer, an absorbance of at least one of the first refrigerator oil discharged from used compressor 200 and the first refrigerator oil sucked into used compressor 200 is measured by the spectrometer. Then, an amount of the first refrigerator oil is measured based on the measured absorbance, and absorbance characteristics indicating a relationship between a predetermined absorbance and the amount of the first refrigerator oil. The method using a spectrometer is disclosed, for example, in Japanese Patent Laying-Open No. 62-043523.

An analyzer is used, for example, to obtain the amount of the additive included in the first data group (see FIG. 5). The analyzer includes a gas chromatograph or a liquid chromatograph.

The second data group is data related to degradation of the sliding portion.

Stated another way, the second data group is data indicating degradation of the sliding portion. The second data group may be referred to as a data group related to degradation of refrigerator oil. As shown in FIG. 5, the second data group includes at least one of a total acid number of the first refrigerator oil and a hue value of the first refrigerator oil.

The total acid number of the first refrigerator oil is measured, for example, in accordance with “JIS K2501.” The total acid number is measured, for example, by an indicator titration method or a potentiometric titration method.

The hue value of the first refrigerator oil is measured, for example, by a hue sensor (such as an absorptiometer). More specifically, an absorbance of at least one of three primary colors (RGB) of the first refrigerator oil is measured as the hue value. The second data group may include at least one of an viscosity of and a moisture concentration in the first refrigerator oil.

The third data group is data related to degradation of used compressor 200. Stated another way, the third data group is data indicating degradation of used compressor 200. As shown in FIG. 5, the third data group includes at least one of: noise of used compressor 200 while used compressor 200 is driven; an amount of vibration of used compressor 200 while used compressor 200 is driven; and an amount of foreign matter included in the first refrigerator oil.

The noise of used compressor 200 is obtained, for example, by driving used compressor 200 before cutting the pipe, and measuring noise by a noise meter during the driving. The amount of vibration of used compressor 200 is obtained, for example, by driving used compressor 200 and measuring vibration by a vibration sensor during the driving. The third data group may include an input current of used compressor 200. The method for measuring the vibration or the input current of used compressor 200 is disclosed, for example, in WO 2019/239549.

The fourth data group is data which may or may not be related to the degree of degradation of the sliding portion. The fourth data group includes at least one of a remaining amount of the antioxidant and an amount of moisture. The antioxidant is added to the refrigerator oil. The amount of moisture is an amount of moisture in the refrigerator oil. The fourth data group may also include the viscosity of the first refrigerator oil and the like.

### Method for Determining Good Parameter

Next, how to determine a method for calculating the good parameter is described in stages. Initially, in a first stage, for example, an operator classifies obtainable data. An example of the classification is as shown in FIG. 5, for example.

Next, as a second stage, the operator selects at least one data from the first to fourth data groups. For example, the operator selects data from at least one of the first data group and the second data group. Data in a data group from which the data is not selected may be an arbitrary fixed value.

Next, as a third stage, the operator calculates, as a first value, a product or a sum of amounts indicated by the data selected from the first data group. Similarly, the operator calculates, as a second value, a product or a sum of amounts indicated by the data selected from the second data group, the third data group, and the fourth data group.

Next, as a fourth stage, the operator calculates a parameter by dividing the first value by the second value. Next, as a fifth stage, the operator compares the calculated parameter with the state of the sliding portion, and considers whether or not a correlation is obtained between the parameter and an amount of wear (wear state) of the sliding portion. As a result, when there is no desired correlation, the parameter is discarded, and when the desired correlation is obtained, the method for calculation (calculation formula) of that parameter is determined as a method for calculating the good parameter.

### Calculation Formula of Good Parameter

Next, a specific example of the calculation formula of the good parameter in step S22 of FIG. 4 is described. In this case, an amount V of the first refrigerator oil in the first data group, an amount A of the additive in the first refrigerator oil in the first data group, a total acid number C of the first refrigerator oil in the second data group, and a hue value D of the first refrigerator oil in the second data group are used (selected) as data for use in calculation of the good parameter. The additive in the refrigerator oil in the first data group is a phosphorus-based antiwear agent, and more specifically, tricresyl phosphate. Hue value D of the first refrigerator oil is a blue absorbance.

A good parameter W is then calculated through the following equation (1):

W=(V×A)/(C×D) (1)

The numerator of the right side of the equation (1) is “a multiplication value (first multiplication value) of amount V of the first refrigerator oil and amount A of the phosphorus-based antiwear agent.” The denominator of the right side of the equation (1) is “a multiplication value (second multiplication value) of total acid number C of the first refrigerator oil and blue absorbance D of the first refrigerator oil.” In the example of the equation (1), good parameter W is calculated by division of the first multiplication value by the second multiplication value.

The value of the numerator in the equation (1) is a multiplication value of the data values belonging to the first data group related to the goodness of the sliding portion. Accordingly, this value of the numerator has a positive effect on the sliding portion. The value of the denominator in the equation (1) is a multiplication value of the data values belonging to the second data group related to the degradation of the sliding portion. Accordingly, this value of the denominator has a negative effect on the sliding portion. It is thus clear that as good parameter W is larger, the sliding portion is better.

The calculation of good parameter W through the equation (1) may be carried out, for example, mentally by the operator, or by use of an information processing apparatus (a personal computer (PC)).

Next, a modification of the calculation formula of the lifetime parameter is described. For example, good parameter W =A may be set. Good parameter W=V×A may be set. Good parameter W=A/C may be set.

In the example of the equation (1), the numerator is the value related to the goodness of the sliding portion, and the denominator is the value related to the degradation of the first refrigerator oil. However, the numerator and the denominator in the equation (1) may be reversed. As a parameter calculated through such an equation is smaller, the sliding portion is better. As described above, the calculation equation of the parameter and the normal range are designed as appropriate based on results of analysis of the collected compressor.

### Setting of Normal Range

Next, a method for setting the normal range is described. First, a plurality of used compressors 200 are prepared. These used compressors 200 may be collected from the market. These used compressors 200 may be manufactured under accelerated conditions simulating a particular market for a new compressor.

For each of the plurality of used compressors 200 thus prepared, the operator calculates the value of usage data (additive amount A in this case) and above-described good parameter W. Then, the operator disassembles each used compressor 200 and observes the condition of the sliding portion. The sliding portion may be only visually observed by the operator. In the case where the sliding portion is only visually observed by the operator, an empirical relative evaluation such as a multi-stage (e.g., three-stage) evaluation is added, for example, for each of the plurality of used compressors thus observed. At least one of the amount of wear of the sliding portion and surface roughness of the sliding portion may be determined by the observation of the sliding portion. By obtaining a correlation between the state of the sliding portion obtained by the operator's observation and good parameter W, the operator can predict, based on this correlation, the condition of the sliding portion from good parameter W.

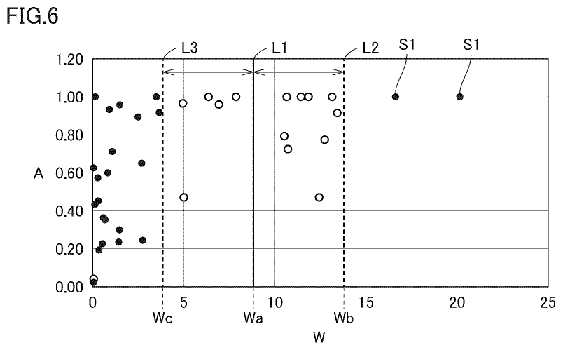

FIG. 6 is a diagram for illustrating this correlation. FIG. 6 is also a diagram for setting the normal range. An exemplary relationship between amount A of the phosphorus-based antiwear agent (additive amount A) and good parameter W is shown in the example of FIG. 6. In the example of FIG. 6, the vertical axis represents A and the horizontal axis represents W. Amount A of the phosphorus-based antiwear agent is a value relative to the amount of the phosphorus-based antiwear agent mixed in a new refrigerator oil which is regarded as “1”. In other words, amount A of the phosphorus-based antiwear agent is a value greater than or equal to 0 and smaller than or equal to 1.

A white circle in FIG. 6 indicates normal wear of the sliding portion. The normal wear refers to a degree of wear at which the compressor is determined to be usable if the second refrigerator oil (new refrigerator oil) is enclosed in the compressor. Usable means, for example, that the compressor can be used to such a degree as to reach the end of a product lifetime acceptable by the market.

A black circle in FIG. 6 indicates abnormal wear of the sliding portion. The abnormal wear refers to a degree of wear at which the compressor is determined to be non-usable even if the second refrigerator oil is enclosed in the compressor. Non-usable means, for example, that the compressor cannot be used to such a degree as to reach the end of a product lifetime acceptable by the market.

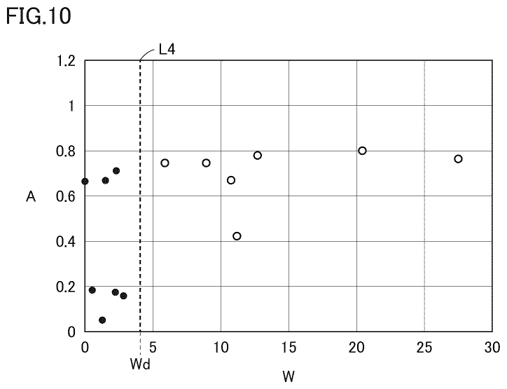

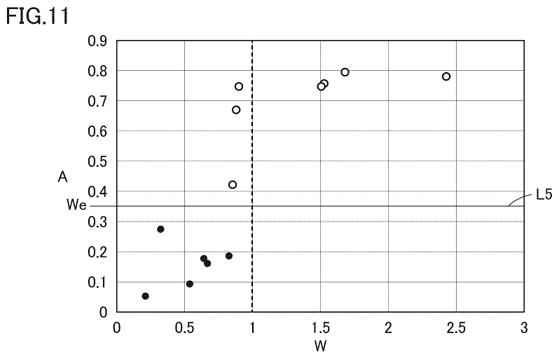

Determination of normal wear or abnormal wear was made by the above-described observation of the sliding portion. A compressor including a sliding portion with normal wear is also referred to as a “normal compressor,” while a compressor including a sliding portion with abnormal wear is also referred to as an “abnormal compressor.” The definitions of the white and black circles also apply to FIGS. 10 and 11 described later.

In FIG. 6, there are compressors indicated by black circles despite large good parameters W (see points S1 in FIG. 6). Each of these compressors is likely to be in a failure mode due to inclusion of foreign matter (biting of foreign matter). The foreign matter is, for example, chips generated during pipe cutting at the time of installation of refrigeration cycle apparatus 100.

In such a failure mode, the refrigerator oil is not degraded. Accordingly, abnormal wear is indicated despite large good parameter W. The reason why abnormal wear is indicated is that a compressor that has hardly been used may have foreign matter included therein, despite almost no degradation of the sliding portion and large good parameter W. The foreign matter can be discharged to the outside as the compressor is used.

As shown in FIG. 6, in the case where the compressors with extremely small good parameters W and the compressors with extremely large good parameters W include the sliding portion with abnormal wear, the state of the sliding portion may be determined based on a mean value and standard deviation of good parameters W of the normal compressors.

A solid line L1 in FIG. 6 indicates a mean value Wa of good parameters W of the normal compressors. A dashed line L2 indicates a value Wb obtained by adding a standard deviation to mean value Wa. A dashed line L2 indicates a value Wc obtained by subtracting the standard deviation from mean value Wa. Stated another way, dashed lines L2 and L3 are upper and lower boundaries when n=1 in “mean value Wat±nσ.” Note that o indicates the standard deviation. The range with Wb as the lower limit value and We as the upper limit value corresponds to the “normal range” in step S24 of FIG. 4.

As for the value of n, for example, the operator may create FIG. 6 and set n such that the abnormal compressors are not included in the normal range. In the example of FIG. 6, n=1 is appropriate. When n is greater than 1, an abnormal compressor may be determined as a normal compressor. When n is smaller than 1, a normal compressor may be determined as an abnormal compressor.

As described above, with the normal range of good parameter W defined, the operator can clearly distinguish between a normal compressor and an abnormal compressor. Stated another way, by analyzing the first refrigerator oil and calculating good parameter W, the operator can determine whether the sliding state is normal or abnormal based on FIG. 6. Further, the operator can determine whether or not used compressor 200 can reach the lifetime acceptable by the market if the second refrigerator oil is enclosed in used compressor 200. In the case where foreign matter has been bitten in used compressor 200, the sliding portion of this used compressor 200 may be determined to be abnormal despite large good parameter W. In order for used compressor 200 including such a sliding portion to be determined as an abnormal compressor, upper limit value Wb is preferably set for good parameter W. The setting of such an upper limit value can allow the operator to determine, for example, a compressor having foreign matter included therein as an abnormal compressor. The normal range may be visually determined by the operator without the use of the mean and standard deviation. As described above, in the example of FIG. 6, the range that includes the normal compressors in the white circles and does not include the abnormal compressors in the black circles (the range between dashed line L3 and dashed line L2) is set as the normal range.

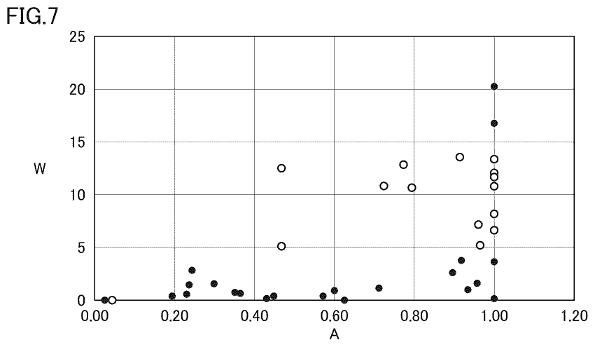

Although good parameter W=A may be set as the calculation formula of good parameter W as described above, an example in which the setting of good parameter W=A is inappropriate is described below. FIG. 7 is a diagram for illustrating such an example. In the example of FIG. 7, the vertical axis represents amount A of the phosphorus-based antiwear agent, and the horizontal axis represents good parameter W. This good parameter W is calculated through the equation (1).

In the example of FIG. 7, as indicated by white circles, amounts A of the phosphorus-based antiwear agent in the normal compressors are distributed in the range from about 0.4 to 1.0. Amounts A of the phosphorus-based antiwear agent in the abnormal compressors are widely distributed from 0 to 1.0.

In the example of FIG. 7, when amount A of the phosphorus-based antiwear agent is smaller than or equal to 0.4, used compressor 200 can be determined as an abnormal compressor. However, even when amount A of the phosphorus-based antiwear agent is from 0.4 to 1.0, used compressor 200 cannot be determined as a normal compressor since abnormal compressors are included in the range from 0.4 to 1.0.

In other words, in this example of FIG. 7, the operator cannot determine whether used compressor 200 is a normal compressor or an abnormal compressor based on the setting of good parameter W=A. Thus, the operator cannot determine whether or not used compressor 200 is reusable. In the case of FIG. 7, therefore, the setting of good parameter W=A is inappropriate. In FIG. 11 described later, an example in which the setting of good parameter W=A is appropriate is described.

An appropriate data value to be used for calculation of the good parameter depends on a category of used compressor 200. The category of used compressor 200 is defined by the type of used compressor 200, the type of the first refrigerator oil contained in used compressor 200, the intended use of a device including used compressor 200, and the like.

The type of used compressor 200 includes, for example, a scroll-type compressor, a rotary-type compressor, and a screw-type compressor. The type of the first refrigerator oil includes polyol ester oil, polyvinyl ether oil, polyalkylene glycol oil, mineral oil, and the like. The intended use of a device including used compressor 200 includes uses for commercial, residential, air conditioning, and refrigeration purposes.

For example, it is preferable for the operator to determine in advance the data value and the normal range for use in calculation of good parameter W, by creating the correlation diagrams of FIGS. 6 and 7 for each of the above-described categories.

### Prediction of Lifetime of New Compressor

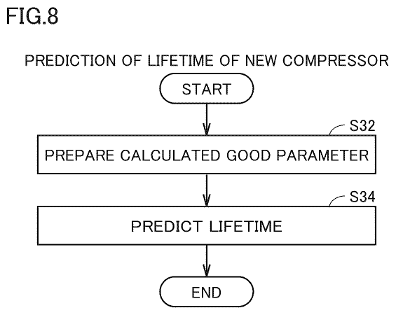

Next, a method for predicting a lifetime of the new compressor manufactured by the method of FIG. 3 is described. FIG. 8 is a flowchart illustrating the method for predicting the lifetime of the new compressor. First, in step S32, a good parameter is prepared. This good parameter is a parameter calculated through the equation (1) and the like in the state of used compressor 200, before the new compressor whose lifetime is to be predicted.

Next, in step S34, the lifetime of the new compressor is predicted based on correlation information created in advance and the calculated good parameter.

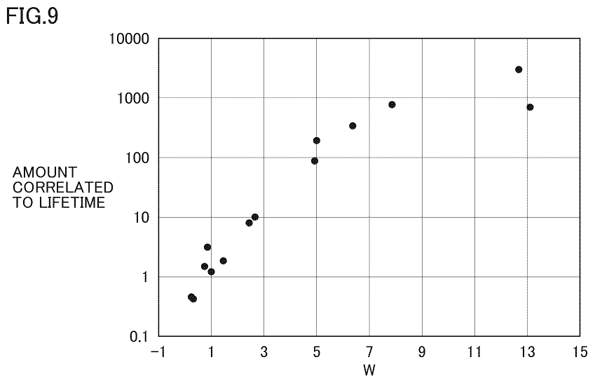

FIG. 9 is a diagram showing exemplary correlation information. In the example of FIG. 9, the horizontal axis represents good parameter W, and the vertical axis represents an amount correlated to the lifetime. In a modification, the vertical axis may represent a value of the lifetime itself instead of the amount correlated to the lifetime. A positive correlation is shown in the example of FIG. 9.

In step S34, the operator calculates good parameter W, and then refers to the correlation information in FIG. 9 to determine the amount correlated to the lifetime corresponding to good parameter W. Then, the operator determines the lifetime based on the amount correlated to the lifetime.

The process of step S34 may be manually executed by the operator. The process of step S34 may be executed, for example, by the operator entering good parameter W to an information processing apparatus and by the information processing apparatus performing a predetermined computation to thereby output (predict) the lifetime. The predetermined computation is, for example, a computation using artificial intelligence (AI).

Next, an exemplary method for creating the correlation information in FIG. 9 is described. The operator assembles compressors each having calculated good parameter W. Then, the operator checks the lifetime of each of the plurality of compressors each having a different state of the sliding portion, by means of an accelerated test and the like. The duration of the accelerated test is preferably converted to a usage time on the market. Since it is assumed that a new compressor will be reused, a new refrigerator oil is enclosed during the assembly of the compressor.

Then, the operator plots calculated good parameter W and the lifetime of the compressor corresponding to this good parameter W in association with each other. The correlation information in FIG. 9 is created based on this plotting.

A lifetime required of the new compressor is defined as a lifetime threshold value. Then, from used compressor 200 from which a good parameter larger than the good parameter corresponding to this lifetime threshold value is obtained, the operator can manufacture a new compressor with a lifetime longer than this lifetime threshold value.

### Conclusion of Present Embodiment

In the present embodiment, as shown in FIG. 3, the operator estimates the degradation state of the sliding portion (step S4). Then, the operator determines whether or not the degradation state satisfies the prescribed criterion (step S6). Then, for used compressor 200 in which the degradation state satisfies the prescribed criterion, the operator manufactures a new compressor by replacing the first refrigerator oil contained in this used compressor 200 with the new second refrigerator oil. With the manufacturing method of the present embodiment, therefore, the operator can reuse the used compressor to manufacture a new compressor at low cost.

In addition, the estimation of the degradation state (step S4) includes calculating the good parameter based on the refrigerator oil data related to the first refrigerator oil (the first data group and the second data group in FIG. 5) (step S22 in FIG. 4). The estimation of the degradation state (step S4) also includes estimating the degradation state based on the good parameter (step S24). Therefore, the operator can estimate the degradation state of the sliding portion in terms of the first refrigerator oil. Further, even when used compressor 200 is a hermetic refrigerant compressor, for example, the operator can estimate the degradation state of the sliding portion without opening and closing a hermetic container.

In addition, the refrigerator oil data includes the first data group related to the goodness of the sliding portion, and the second data group related to the degradation of the first refrigerator oil. Therefore, the operator can estimate the degradation state of the sliding portion in terms of the goodness of the sliding portion and the degradation of the first refrigerator oil.

In addition, the first data includes at least one of the amount of the first refrigerator oil and the amount of the additive in the first refrigerator oil. Therefore, the operator can estimate the degradation state of the sliding portion in terms of at least one of the amount of the first refrigerator oil and the amount of the additive in the first refrigerator oil.

In addition, the second data includes at least one of the total acid number of the first refrigerator oil and the hue value of the first refrigerator oil. Therefore, the operator can estimate the degradation state of the sliding portion in terms of at least one of the total acid number of the first refrigerator oil and the hue value of the first refrigerator oil.

In addition, the estimation of the degradation state may include estimating the degradation state based on the refrigerator oil data and the compressor data related to the degradation of the used compressor. Therefore, the operator can estimate the degradation state of the sliding portion in terms of the degradation of used compressor 200.

In addition, as shown in FIG. 5, the compressor data includes at least one of: the noise of the used compressor while the used compressor is driven; the amount of vibration of the used compressor while the used compressor is driven; and the amount of foreign matter included in the first refrigerator oil. Therefore, the operator can estimate the degradation state of the sliding portion in terms of at least one of: the noise of the used compressor while the used compressor is driven; the amount of vibration of the used compressor while the used compressor is driven; and the amount of foreign matter included in the first refrigerator oil.

In addition, the good parameter is calculated, for example, through the above-described equation (1). Therefore, the operator can estimate the degradation state of the sliding portion through a relatively simple arithmetic operation.

In addition, according to the lifetime estimation method of the present embodiment, the lifetime of the new compressor can be predicted based on the good parameter calculated in step S22, as shown in FIG. 8. Stated another way, the operator can use the good parameter calculated in step S22 also to predict the lifetime of the new compressor. Therefore, the operator can predict the lifetime of the new compressor without disassembling the new compressor.

### Second Embodiment

In the example described in the first embodiment, tricresyl phosphate is mainly used as the antiwear agent. In an example described in a second embodiment, triphenyl phosphate is used as the antiwear agent. In the second embodiment, the used compressor is a scroll-type hermetic compressor, which is collected after being subjected to an accelerated test under various conditions.

A calculation formula of good parameter W of the second embodiment is represented by the following equation (2):

W=(V×A)/C (2)

FIG. 10 is a diagram for illustrating a method for determining a normal range of the second embodiment. FIG. 10 is a diagram showing a relationship between the amount of the antiwear agent which is tricresyl phosphate (additive amount A) and good parameter W calculated through the equation (2). In FIG. 10, the vertical axis represents additive amount A, and the horizontal axis represents good parameter W. A dotted line L4 in FIG. 10 indicates a value Wd. Value Wd is a mean value of good parameters W of abnormal compressors plus n (n=3 in this case) standard deviations of these good parameters W. As shown in FIG. 10, in the case where the plots of abnormal compressors are concentrated in the range where good parameter W is small, the operator may set the normal range by the lower limit value without the upper limit value.

Note that above-described n=3 is a value established to distinguish between an abnormal compressor and a normal compressor, and is adjusted depending on the state of distinction between them. Further, when the aim is to identify a normal compressor, it is desirable to provide the normal range such that abnormal compressors are not mixed in among normal compressors, and normal compressors may be mixed in among abnormal compressors without causing any particular disadvantages. Good parameter W may be used to determine an abnormal compressor.

As described above in the second embodiment, the normal range may be defined only by the lower threshold value without the upper threshold value.

Although not particularly shown, the normal range may be defined only by the upper threshold value without the lower threshold value.

### Third Embodiment

FIG. 11 is a diagram showing another exemplary relationship between additive amount A and good parameter W. When a result of the analysis results in what is shown in FIG. 11, good parameter W=A may be set, for example. The normal range (lower threshold value) of good parameter W (additive amount A) is then defined by a value We indicated by a line L5. Thus, good parameter W may be one of the data shown in FIG. 5 (in the present embodiment, additive amount A in the first data).

### Fourth Embodiment

Using the good parameter described in FIGS. 3 and 4, the operator can determine the state of the sliding portion of the compressor without disassembling the compressor. Therefore, using the good parameter of compressor 200 which remains connected to refrigeration cycle apparatus 100 in FIG. 1, the operator can determine the state of the sliding portion of this compressor 200.

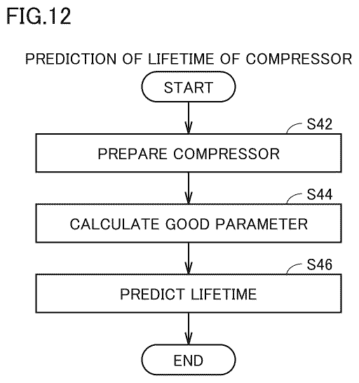

Therefore, prediction of the lifetime of compressor 200 connected to refrigeration cycle apparatus 100 is described in the present embodiment. FIG. 12 is an exemplary flowchart of a lifetime prediction method of the present embodiment.

In step S42, compressor 200 whose lifetime is to be predicted is prepared. In the case where compressor 200 is connected to refrigeration cycle apparatus 100, this refrigeration cycle apparatus 100 is prepared.

Next, in step S44, a good parameter of this compressor is calculated. The equation (1) is used, for example, as the calculation formula. Another formula may be used in a modification. Then, in step S46, the lifetime of compressor 200 is predicted based on the good parameter and correlation information created in advance.

Next, an exemplary method for obtaining data for use in calculation of good parameter W is described. For example, the operator extracts a small amount of the first refrigerator oil in compressor 200 through a valve or the like that drains the first refrigerator oil. Then, the operator obtains usage data by the above-described method. The amount of the first refrigerator oil extracted preferably does not affect the operation of refrigeration cycle apparatus 100.

The correlation information used in step S46 is, for example, the correlation information shown in FIG. 9. Thus, the correlation information is information indicating the correspondence between good parameter W and the lifetime.

In other words, the lifetime prediction method disclosed in the fourth embodiment is described as follows. The lifetime prediction method includes; preparing a compressor (a compressor whose lifetime is to be predicted); calculating a parameter (a good parameter) based on refrigerator oil data related to a first refrigerator oil of the compressor; and predicting a lifetime of the compressor based on the parameter.

Particularly, for the calculation of the good parameter, the above-described equation (1) or the like is used. For the calculation of the good parameter, not only the amount of the first refrigerator oil in the first data group but other data may be used to improve the accuracy of lifetime prediction. The other data is, for example, at least one of: the amount of the additive in the first refrigerator oil; the total acid number of the first refrigerator oil; and the hue value of the first refrigerator oil. According to the lifetime prediction method of the present embodiment, the lifetime of compressor 200 whose lifetime is to be predicted can be predicted without disconnection of this compressor 200 from refrigeration cycle apparatus 100.

It should be understood that the embodiments disclosed herein are illustrative and non-restrictive in every respect. The scope of the present disclosure is defined by the terms of the claims, rather than the description above, and is intended to include any modifications within the meaning and scope equivalent to the terms of the claims.

### REFERENCE SIGNS LIST

2 condenser; 3 expansion valve; 4 evaporator; 5 refrigerant circuit; 5a, 5b, 5c, 5d pipe; 6, 7 blower; 8 shell; 9 compression mechanism; 10 suction pipe; 11 discharge pipe; 12 shaft; 13 oil receptacle; 14 oil supply hole; 16 bearing; 17 rotor; 18 stator; 30 sliding portion; 100 refrigeration cycle apparatus; 200 compressor.

1. A method for manufacturing a compressor, the method comprising:
preparing a used compressor collected from a market;
estimating a degradation state of a sliding portion of the used compressor; and
manufacturing a new compressor by replacing a first refrigerator oil contained in the used compressor with a new second refrigerator oil, the degradation state in the used compressor satisfying a prescribed criterion, wherein
the estimating the degradation state includes
calculating a parameter based on refrigerator oil data related to the first refrigerator oil, and
estimating the degradation state based on the parameter.

2. (canceled)

3. The method for manufacturing a compressor according to claim 1, wherein
the refrigerator oil data includes at least one of
first data related to goodness of the sliding portion, and
second data related to degradation of the first refrigerator oil.

4. The method for manufacturing a compressor according to claim 3, wherein
the first data includes at least one of
an amount of the first refrigerator oil, and
an amount of an additive in the first refrigerator oil.

5. The method for manufacturing a compressor according to claim 3, wherein
the second data includes at least one of
a total acid number of the first refrigerator oil, and
a hue value of the first refrigerator oil.

6. The method for manufacturing a compressor according to any claim 1, wherein
the estimating the degradation state includes estimating the degradation state based on the refrigerator oil data and compressor data related to degradation of the used compressor.

7. The method for manufacturing a compressor according to claim 6, wherein
the compressor data includes at least one of
noise of the used compressor while the used compressor is driven,
an amount of vibration of the used compressor while the used compressor is driven, and
an amount of foreign matter included in the first refrigerator oil.

8. The method for manufacturing a compressor according to claim 1, wherein
the refrigerator oil data is
an amount of the first refrigerator oil,
an amount of a phosphorus-based antiwear agent mixed in the first refrigerator oil,
a total acid number of the first refrigerator oil, and
a blue absorbance of the first refrigerator oil, and
the parameter is calculated by division of a multiplication value of the amount of the first refrigerator oil and the amount of the phosphorus-based antiwear agent by a multiplication value of the total acid number and the blue absorbance.

9. A method for predicting a lifetime of a compressor, the method comprising predicting, based on the parameter, a lifetime of the new compressor manufactured by the method for manufacturing a compressor according to claim 1.
